(19) United States
(12) Patent Application Publication
(10) Pub. No.: US 2022/0027786 A1
(43) Pub. Date: Jan. 27, 2022

(54) Multimodal Self-Paced Learning with a Soft Weighting Scheme for Robust Classification of Multiomics Data

(71) Applicant: Macau University of Science and Technology, Macau (CN)

(72) Inventors: Yong LIANG, Macau (CN); Ziyi YANG, Macau (CN)

(21) Appl. No.: 16/947,234

(22) Filed: Jul. 24, 2020

(51) Int. Cl. G06N 20/00; G06K 9/62; G06F 17/16

(52) U.S. Cl. CPC G06N 20/00; G06F 17/16; G06K 9/628

(57) ABSTRACT

A robust multimodal data integration method, termed the SMSPL technique, aimed at simultaneously predicting subtypes of cancers and identifying potentially significant multiomics signatures, is provided. The SMSPL technique leverages linkages among different types of data to interactively recommend high-confidence training samples during classifier training. Particularly, a new soft weighting scheme is adopted to assign weights to training samples of each type, thus more faithfully reflecting latent importance of samples in self-paced learning. The SMSPL technique iterates between calculating the sample weights from training loss values and minimizing weighted training losses for classifier updating, allowing the classifiers to be efficiently trained. In classifying a test sample, outputs of the trained classifiers are integrated to yield a class label by solving an optimization problem for minimizing a sum of classifier losses in selecting a candidate class label, making the SMSPL technique more accruable to discriminate equivocal samples.

### BACKGROUND

### Field of the Invention

The present disclosure generally relates to multimodal classification of multimodal data with applications to classification of multiomics data. In particular, the present disclosure relates to using a plurality of classifiers for collectively classifying a test sample consisting of observation data vectors obtained from plural modalities and to training the plurality of classifiers using a multimodal self-paced (SP) learning technique.

### Description of Related Art

With rapidly evolving high-throughput technologies, it is progressively easier to collect diverse and multiple biological datasets for research on clinical and biological issues. For instance, the Cancer Genome Atlas (TCGA, https://tcga-data.nci.nih.gov) provides most comprehensive multiple types of omics data for over 20 types of cancers from thousands of patients. Simultaneous analysis of multiple omics (multiomics) data, such as gene expression, miRNA expression, protein expression, DNA methylation, and copy number variation data, is an important task in integrative systems biology method. It provides improved biological insights compared with single-omics analysis, as well as a more comprehensive global view of a biological system. The integration of multiomics data is expected to provide an opportunity for an in-depth understanding of biological processes, prediction of cancer subtypes, and discovery of potentially significant multiomics signatures.

The problem of learning predictive methods from multiomics data can be naturally regarded as a multimodal learning problem, where each omics dataset provides a distinct modality of the complex biological information. Multimodal machine learning aims to construct models that can process and relate information from multiple modalities. Current supervised multiomics integrative analysis methods for classification and identification of significant signatures are concatenation-based, ensemble-based, and knowledge-driven.

The concatenation-based data integration is the simplest way to bring all features together prior to applying the prediction model. The ensemble-based integration builds a classification model separately on each individual modality and combines the prediction results based on the average or majority voting scheme. However, these two types of methods may be biased towards certain types of omics data, and cannot effectively learn the inherent relationships among multiple modalities. Recently, classification methods, such as Generalized Elastic Net (EN), smoothed t-statistic Support Vector Machine (stSVM), sparse Partial Least Squares Discriminant Analysis (sPLSDA), and adaptive Group-Regularized (logistic) ridge regression, have been applied to meta-analysis of biological data, such as gene pathway data, protein-protein interaction (PPI) networks, miRNA-target gene networks, gene expression data, and DNA methylation data. The applicability of these methods is still limited to the analysis of a single-omics data; either concatenation or ensemble framework should be applied for incorporation of other omics data. However, neither one of the above two types of integration frameworks can account for model relationships between different types of data, which restricts the understanding of interaction between different biological processes.

Knowledge-driven multimodal data integration establishes model relationships between different modalities by taking the prior knowledge into account. DIABLO (Data Integration Analysis for Biomarker discovery using Latent cOmponents) has been proposed to seek common information across different modality data by selecting a subset of features and discriminating multiple subtypes simultaneously. Actually, it extends the sparse generalized canonical correlation analysis (SGCCA) to a supervised classification framework. SGCCA studies the relevant information between and within multiple sets of features and maximizes the covariance between linear combinations of features. However, linearity assumption between multiple sets of features may not be suitable for some biological research fields. Moreover, DIABLO can be easily plagued by heavy noise and is not a robust learning strategy for multimodal data analysis.

High noise is one of the major computational challenges for multiomics data integration. Random noise or system/collection bias in samples may be prone to overfitting issue and lead to poor generalization performance. Sample reweighting method is a typically used strategy against this robust learning issue. The sample weights are usually calculated based on training loss. There exist two contradicting views in training loss methods. One approach is to prioritize samples with higher training loss values since they are more likely to be uncertain complex samples locating at the classification boundary, such as AdaBoost [1], hard negative mining [7] and focal loss [2]. The other approach is to choose samples with smaller training loss values as easy samples, such as SP learning [3], its variants [4]-[6] and iterative reweighting [8], [9]. The latter approach has been widely used in heavy noise scenarios, and it prefers to select samples with smaller training loss values since they are more likely to be high-confidence samples.

Despite all the aforementioned efforts, there is a need in the art for a technique of training a multimodal classifier so as to more robustly integrating the multiomics data in the presence of random noise and bias in training samples. Apart from applications to the multiomics data, the technique is also applicable for multimodal classification of general multimodal data.

### SUMMARY OF THE INVENTION

Mathematical equations referenced in this Summary can be found in Detailed Description.

A first aspect of the present disclosure is to provide a method for training m classifiers. The m classifiers are collectively used for classifying a test sample consisting of m observation data vectors respectively obtained from m modalities where m≥2. A j-th classifier is used for classifying a j-th observation data vector generated from a j-th modality where 1≤j≤m. The j-th classifier include a plurality of model parameters updatable during training such that the m classifiers include m pluralities of model parameters

The training method comprises the steps of: (a) obtaining a multimodal training dataset comprising n training samples for training the m classifiers, wherein an individual training sample comprises m observation data vectors and a predetermined class label; (b) initializing m latent weight vectors, m age parameters, an inter-modality influencing factor and the m pluralities of model parameters, wherein a j-th latent weight vector comprises n latent weights each indicating a degree of importance of a j-th observation data vector of a respective training sample during training the j-th classifier, wherein a j-th age parameter is used for adjusting a learning pace in self-paced learning of the j-th classifier during training, and wherein the inter-modality influencing factor is used for adjusting a degree of influence of a k-th latent weight vector to training the j-th classifier where k≠j, the inter-modality influencing factor being same for j=1, . . . , m; and (c) repeating an iterative process for iteratively updating the m pluralities of model parameters until one of predefined terminating conditions occurs. In particular, the iterative process comprises the steps of: (d) updating the m latent weight vectors according to the m age parameters, the inter-modality influencing factor and the m pluralities of model parameters; (e) updating the m pluralities of model parameters according to the dataset and the m latent weights; and (f) after the steps (d) and (e) are performed, incrementing the m age parameters.

In the step (d), preferably, the m latent weights are updated by EQN. (15).

In the iterative process, the step (d) may be performed before or after the step (e).

In the step (b), the m pluralities of model parameters may be initialized with model-parameter values obtained in a previous training phase, or with predetermined model-parameter values.

In the step (e), the m pluralities of model parameters may be updated by EQN. (17).

In the step (c), the predefined terminating conditions may include a first condition that a predetermined number of iterations are performed, a second condition that the m pluralities of model parameters converge, or a third condition that all the n training samples are selected for training the m classifiers.

A second aspect of the present disclosure is to provide a method for classifying a test sample to yield a classification result. The test sample consists of m observation data vectors obtained from m modalities where m≥2.

The classifying method comprises: using m classifiers to respectively process the m observation data vectors, whereby m classifier outputs are generated; determining the classification result according to the m classifier outputs; and before using the m classifiers to process the m observation data vectors, training the m classifiers according to any of the embodiments of the training method.

Preferably, the classification result is determined from the m classifier outputs by EQN. (18).

In certain embodiments, each of the m modalities is a single omics modality.

Other aspects of the present invention are disclosed as illustrated by the embodiments hereinafter.

### BRIEF DESCRIPTION OF THE DRAWINGS

FIG. 1 depicts a flowchart showing exemplary steps of a disclosed method of training a plurality of classifiers for multimodal classification.

FIG. 2 depicts a flowchart showing exemplary steps of a disclosed method of classifying a test sample consisting of plural observation data vectors obtained from plural modalities.

### DETAILED DESCRIPTION

To more robustly integrating multiomics data in the presence of random noise and bias in training samples, the present disclosure provides a robust multimodal learning technique for multiomics data integration, termed multimodal self-paced learning with a soft weighting scheme (SMSPL). The SMSPL technique is aimed at simultaneously identifying potentially important multiomics signatures and predicting subtypes of cancers during the multiomics data integration process. The main idea of the SMSPL technique is to interactively recommend high-confidence samples among multiple modalities and embeds curriculum design to learn a model for each modality by gradually increasing samples from easy to complex ones during training. Particularly, it adopts a new soft weighting scheme to assign real-valued weights to training samples, thereby more faithfully reflecting latent importance of training samples in learning. The SMSPL technique iterates between calculating the sample weights from the training loss values and minimizing the weighted training losses for classifier updating.

Before the SMSPL technique is elaborated, a background on SP learning is provided.

Consider a classification problem with an input dataset [symbol] ={(xᵢ, yᵢ)}ᵢ₌₁ⁿ, where xᵢ=(xᵢ₁, xᵢ₂, . . . , xᵢₚ) denotes an i-th sample containing p features, n denotes the number of input samples, and yᵢ denotes the class label of the i-th sample (e.g. yᵢ∈{0,1} for binary classification). Let f(xᵢ, β) represent a classifier under consideration, where β denotes a plurality of model parameters used for characterizing the classifier. In particular, f(xᵢ, β) is a classifier output of the classifier under xᵢ and β. Let L(yᵢ, f(xᵢ, β)) represent a loss function for calculating a loss value between yᵢ, a truth label, and f(xᵢ, β), a predicted label. The objective in a traditional machine learning model takes the form of ‘loss plus penalty’, expressed as:

$${min}_{β} E ( β ; λ ) = {\sum }_{i = 1}^{n} L ( {y}_{i} , f ( {x}_{i} , β ) ) + λ P ( β ) \qquad ( 1 )$$

where P(β) is a regularization term for avoiding overfitting due to, e.g., noise, and λ is a tuning parameter of the regularization term for controlling an amount of shrinkage. As the most popularly used regularization technique, Lasso (L₁) is given as P(β)=∥β∥₁. The Lasso penalty function is adopted as an exemplary penalty function used for feature extraction in illustrating the present disclosure, though other penalty functions, such as L_{1/2}, may be used.

Self-paced learning (SPL) [3] introduces a SP regularization term into the learning objective to adaptively learn the model in a meaningful order. A latent weight vector ν=[ν₁, ν₂, . . . , νₙ]^{T} representing importance of each training sample is embedded into EQN. (1). In SPL, the goal is to jointly learn the latent weight vector ν and the plurality of model parameters β by solving the following minimization problem:

$${min}_{β , {vϵ [ 0 , 1 ]}^{n}} E ( β , v ; λ , γ ) = {\sum }_{i = 1}^{n} {v}_{i} L ( {y}_{i} , f ( {x}_{i} , β ) ) + λ P ( β ) + g ( v , γ ) \qquad ( 2 )$$

where γ denotes an age parameter for adjusting the learning pace, and g(ν, γ) denotes a SP regularizer. In [3], based on the negative L₁-norm of ν∈[0,1]ⁿ, the SP regularizer is defined as:

$$g ( ν , γ ) = - γ {‖ ν ‖}_{1} = - γ {\sum }_{i = 1}^{n} {v}_{i} . \qquad ( 3 )$$

An alternative optimization strategy (AOS) algorithm is a typically used method to solve the optimization problem given by EQN. (2). This algorithm is a biconvex optimization algorithm that alternatingly updates the latent weight vector ν and the plurality of model parameters β in an iterative way. Specifically, in each iteration, one of ν and β is optimized while keeping the other fixed. For example, when β is held fixed, by substituting EQN. (3) back into EQN. (2), the latent weight σᵢ* of the i-th training sample can be updated as:

$${v}_{i}^{*} = \{ \begin{matrix}1 , & L ( {y}_{i} , f ( {x}_{i} , β ) ) < γ \\ 0 , & otherwise\end{matrix} . \qquad ( 4 )$$

An intuitive explanation behind this alternative search strategy can be given as follows.
1. Update ν while keeping β fixed. A sample whose loss value L(·) is smaller than the age parameter γ is regarded as a high-confidence sample such that νᵢ=1 is set, otherwise νᵢ=0. As a result, high-confidence samples are identified and selected.
2. Update β while keeping ν fixed. The classifier is trained by using the selected high-confidence samples only.
3. The age parameter γ gives the number of samples to be selected in the learning process. With the increase of γ, more samples are automatically fed into the training pool from simple to complex in a purely self-paced way.

In fact, the SP regularizer in EQN. (3) corresponds to a binary learning scheme since νᵢ can only take a binary value. This strategy is termed as Hard Weighting, which cannot accurately discriminate the latent importance of samples. To tackle this issue, by setting a weight with a real number, Soft Weighting reflects the importance of samples in the learning process more realistically.

The work in [4] proposes a formal definition of SP regularizer g(ν; γ), which provides an axiomatic understanding of SPL. Suppose that ν is a latent weight, and can be optimized by

$${v}^{*} ( ℓ , γ ) = {arg min}_{v ∈ [ 0 , 1 ]} ( v ℓ + g ( v ; γ ) ) \qquad ( 5 )$$

where [symbol] is a loss and γ is an age parameter. In a linear scheme, the training samples are linearly discriminated with respect to losses of these samples. The SP function and a closed-form solution thereof ν*( [symbol] , γ) are given as:

$${g}^{L i n e a r} ( v ; γ ) = γ ( \frac{1}{2} {v}^{2} - v ) ; \\ {v}_{L i n e a r}^{*} ( ℓ , γ ) = \{ \begin{matrix}- \frac{ℓ}{γ} + 1 , & if ℓ < γ \\ 0 , & if ℓ \geq γ\end{matrix} . \qquad ( 6 )$$

In a logarithmic scheme, it is a more conservative learning scheme, which penalizes losses in a logarithmic manner. The SP function and its closed-form solution are expressed as:

$${g}^{L o g} ( v ; ζ ) = ζ v - \frac{{ζ}^{v}}{log ζ} ; \\ {v}_{L o g}^{*} ( ℓ , γ , ζ ) = \{ \begin{matrix}\frac{log ( ℓ + ζ )}{log ζ} , & if ℓ < γ \\ 0 , & if ℓ \geq γ\end{matrix} \qquad ( 7 )$$

where ζ=1−γ and 0<γ<1. In a mixture scheme, this learning scheme is a hybrid one by combining hard and soft weighting schemes. Compared with the soft weighting scheme, the mixture scheme gives no penalty on small losses within a certain threshold. The SP function of the mixture scheme and the closed-form optimal solution are given by:

$${g}^{M i x} ( v ; γ , φ ) = \frac{{φ}^{2}}{v + φ / γ} ; \\ {v}_{M i x}^{*} ( ℓ , γ , φ ) = \{ \begin{matrix}1 , & if ℓ < ( \frac{γφ}{γ + φ} {)}^{2} \\ 0 , & if ℓ \geq {γ}^{2} \\ φ ( \frac{1}{\sqrt{ℓ}} - \frac{1}{γ} ) , & otherwise .\end{matrix} \qquad ( 8 )$$

EQN. (8) tolerates any loss value smaller than p by assigning a full weight.

A theoretical framework of the SMSPL technique is elaborated hereinafter by integrating multimodal datasets for training, feature selection and classification.

Consider a classification problem with a multimodal training dataset [symbol] ={(xᵢ⁽¹⁾, . . . , xᵢ^{(m)}, yᵢ)}ᵢ₌₁ⁿ having n training samples, where (xᵢ⁽¹⁾, . . . , xᵢ^{(m)}) is an i-th training sample, xᵢ^{(j)}=(xᵢ₁^{(j)}, xᵢ₂^{(j)}, . . . , xᵢₚ_{ⱼ}^{(j)}) for j∈{1, . . . , m} is a j-th observation data vector of the i-th training sample with pⱼ features under a j-th modality, yᵢ is a predetermined class label (truth label) of the i-th training sample, n is the number of training samples in the dataset, and m is the number of modalities. Note that there are m observation data vectors in an individual training sample. It is desired to use m classifiers to process the m observation data vectors for each training sample in order that the m classifiers are trained. Let f^{(j)}(x^{(j)}, β^{(j)}) represent a j-th classifier, where β^{(j)} is a plurality of model parameters to be estimated under the j-th modality. (Note that β^{(j)} is regarded as a vector.) Specifically, f^{(j)}(x^{(j)}, β^{(j)}) is a classifier output of the j-th classifier under x^{(j)} and β^{(j)}. Note that the m classifiers have m pluralities of model parameters to be estimated. Let L(yᵢ, f(xᵢ^{(j)}, β^{(j)})) represent a loss function under the j-th modality. The loss function computes a loss of selecting yᵢ, a truth label, given that the j-th classifier yields a predicted label f^{(j)}(x^{(j)}, β^{(j)}). The SMSPL technique is realized by optimizing the following problem:

$${min}_{{β}^{( j )} , {v}^{( j )} ∈ {[ 0 , 1 ]}^{n} , j = 1 , 2 , . . . , m} E ( {β}^{( j )} , {ν}^{( j )} ; {λ}^{( j )} , {γ}^{( j )} , δ ) = {\sum }_{j = 1}^{m} {\sum }_{i = 1}^{n} {v}_{i}^{( j )} L ( {y}_{i} , {f}^{( j )} ( {x}_{i}^{( j )} , {β}^{( j )} ) ) + {\sum }_{j = 1}^{m} {λ}^{( j )} {‖ {β}^{( j )} ‖}_{1} - {\sum }_{j = 1}^{m} {\sum }_{i = 1}^{n} {γ}^{( j )} {v}_{i}^{( j )} + \frac{δ}{2 ( m - 1 )} {\sum }_{j = 1}^{m} {\sum }_{k = 1 , k \neq j}^{m} {‖ {ν}^{( j )} - {ν}^{( k )} ‖}_{2}^{2} \qquad ( 9 )$$

where: ν^{(j)}=(ν₁^{(j)}, . . . , νₙ^{(j)}) is a j-th latent weight vector comprising n latent weights in which νᵢ^{(j)} is a latent weight used for indicating a degree of importance of xᵢ^{(j)}, i.e. the j-th observation data vector of the i-th training sample, during training the j-th classifier; λ^{(j)} is a tuning parameter of a regularization term ∥β^{(j)}∥₁ for the j-th classifier; γ^{(j)} is an age parameter under the j-th modality, denoted as a j-th age parameter, which is used for adjusting a learning pace in SP learning of the j-th classifier during training; and δ is an inter-modality influencing factor used for adjusting a degree of influence of a k-th latent weight vector, k≠j, to training the j-th classifier. Note that the inter-modality influencing factor δ is the same for j=1, . . . , m.

Actually, the SMSPL technique corresponds to a sum of the SPL model under multiple modalities plus a new regularization term Σⱼ₌₁^{m} Σ_{k=1,k≠j}^{m}∥ν^{(j)}−ν^{(k)}∥₂². The squared Euclidean distance encodes the relationship of “sample easiness degree” between two modalities. The new regularization term delivers the basic assumption under multimodal learning that different modalities share common knowledge of sample confidence such that the squared Euclidean distance enforces the latent weight to penalize the loss of one modality to that of other modalities. That is, the confidence of a training sample in one modality is more likely to be determined based on the recommended information of other modalities.

An AOS algorithm is used to jointly update the m pluralities of model parameters, namely, β⁽¹⁾, . . . , β^{(m)}, and the m latent weight vectors, i.e. ν⁽¹⁾, . . . , ν^{(m)}, in an iterative way to guarantee efficiency of the SMSPL technique.

In the present disclosure, the SMSPL technique is realized as a training method and a classifying method. The classifying method is integrated with an embodiment of the training method. Embodiments of the training method are developed based on the theoretical framework of the SMSPL technique as disclosed above and the application of the AOS algorithm.

The classifying method is aimed at using the m classifiers to classify a test sample. The test sample consists of m observation data vectors respectively obtained from the m modalities where m≥2. A j-th classifier is used for classifying a j-th observation data vector generated from a j-th modality where 1≤j≤m. As mentioned above, the j-th classifier includes a plurality of model parameters updatable during training, so that the m classifiers include m pluralities of model parameters. The test sample is processed by the m classifiers after the m classifiers are trained.

Although the training method and the classification method are particularly designed for working with multiomics data in the field of bioinformatics, the disclosed training and classifying methods developed from the SMSPL technique are not limited to applications with multiomics data; the disclosed methods are also applicable to general multimodal data.

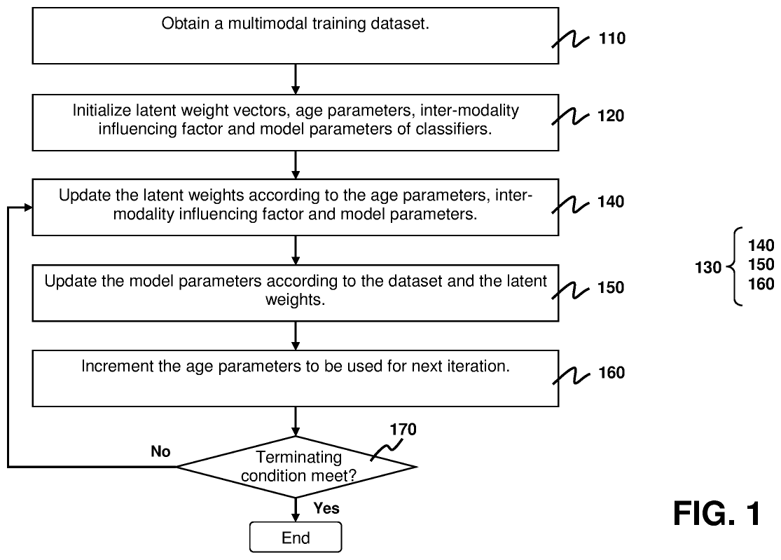

A first aspect of the present disclosure to provide the training method for training the m classifiers. The training method is exemplarily illustrated with the aid of FIG. 1, which depicts a flowchart showing exemplary steps of the disclosed training method.

In a step 110, the multimodal training dataset [symbol] comprising the n training samples is obtained. As mentioned above, an individual training sample comprises m observation data vectors and a predetermined class label.

In a step 120, the m latent weight vectors, the m age parameters, the inter-modality influencing factor and the m pluralities of model parameters are initialized. It is preferable to set: ν⁽¹⁾, ν⁽²⁾, . . . , ν^{(m)} as zero vectors in [symbol] ^{m}; and γ⁽¹⁾, γ⁽²⁾, . . . , γ^{(m)} as small values so as to select a small number of training samples during an initial learning process. The inter-modality influencing factor δ is chosen as a specific value in the whole training process. The m pluralities of model parameters β⁽¹⁾, . . . , β^{(m)} may be initialized with predetermined model-parameter values. In certain applications of classification, β⁽¹⁾, . . . β^{(m)} may be alternatively initialized with model-parameter values obtained in a previous training phase. In the latter case, the goal of training is to update or tune the m pluralities of model parameters in light of availability of new training data.

After the initialization step 120 is performed, an iterative process 130 is initiated. The iterative process 130 is part of the AOS algorithm used in the SMSPL technique. The iterative process 130 includes steps 140, 150 and 160.

In the step 140, the m latent weight vectors are updated according to the m age parameters, the inter-modality influencing factor and the m pluralities of model parameters. The updated latent weight vectors are derived as follows.

By calculating the first order derivative of EQN. (9) with respect to νᵢ^{(j)}, one gets

$$\frac{\partial E}{\partial {v}_{i}^{( j )}} = {L}_{i}^{( j )} - {γ}^{( j )} + \frac{δ}{m - 1} {{\sum }_{1 \leq k \leq m}}_{k \neq j} ( {v}_{i}^{( j )} - {v}_{i}^{( k )} ) = 0 \qquad ( 10 )$$

where Lᵢ^{(j)}=L(yᵢ, f(xᵢ^{(j)}, β^{(j)})) for convenience. With νᵢ^{(j)}∈[0,1], and with β^{(j)} fixed, the latent weight νᵢ^{(j)} of the i-th training sample under the j-th modality can be optimized as

$${v}_{i}^{( j ) *} ( {L}_{i}^{( j )} , {γ}^{( j )} , δ ) = {arg min}_{{v}_{i}^{( j )} ∈ [ 0 , 1 ]} ( {v}_{i}^{( j )} {L}_{i}^{( j )} + g ( {v}_{i}^{( j )} ; {γ}^{( j )} , δ ) ) \qquad ( 11 )$$

where νᵢ^{(j)*} denotes the corresponding optimized latent weight, and the SP regularizer under the j-th modality is given by

$$g ( {v}_{i}^{( j )} ; {γ}^{( j )} , δ ) = - {γ}^{( j )} {v}_{i}^{( j )} + \frac{δ}{2 ( m - 1 )} {\sum }_{k \neq j}^{m} {( {v}_{i}^{( j )} - {v}_{i}^{( k )} )}^{2} . \qquad ( 12 )$$

Since EQN. (12) is a convex function of νᵢ^{(j)}, the global minimum can be obtained at

$${∇}_{{v}_{i}^{( j )}} {E}_{β} ( {v}_{i}^{( j )} ) = 0.$$

It follows that

$$\frac{\partial E}{\partial {v}_{i}^{( j )}} = {L}_{i}^{( j )} - {γ}^{( j )} + \frac{δ}{m - 1} {{\sum }_{1 \leq k \leq m}}_{k \neq j} ( {v}_{i}^{( j )} - {v}_{i}^{( k )} ) = {L}_{i}^{( j )} - {γ}^{( j )} + δ {v}_{i}^{( j )} - \frac{δ}{m - 1} {\sum }_{{1 \leq k \leq m}_{k \neq j}} {v}_{i}^{( k )} = 0 \qquad ( 13 )$$

so that

$${γ}^{( j )} - {L}_{i}^{( j )} + \frac{δ}{m - 1} {\sum }_{{1 \leq k \leq m}_{k \neq j}} {v}_{i}^{( k )} = δ {v}_{i}^{( j )} . \qquad ( 14 )$$

Given that νᵢ^{(j)}∈[0,1], the closed-form optimal solution for the latent weight νᵢ^{(j)} of the i-th training sample under the j-th modality is given by

$${v}_{i}^{( j ) *} = \{ \begin{matrix}1 , & if {L}_{i}^{( j )} < {γ}^{( j )} + \frac{δ}{m - 1} {\sum }_{{1 \leq k \leq m}_{k \neq j}} {v}_{i}^{( k )} - δ , \\ 0 , & if {L}_{i}^{( j )} > {γ}^{( j )} + \frac{δ}{m - 1} {\sum }_{{1 \leq k \leq m}_{k \neq j}} {v}_{i}^{( k )} , \\ \frac{{γ}^{( j )} - {L}_{i}^{( j )}}{δ} + \frac{1}{m - 1} {\sum }_{{1 \leq k \leq m}_{k \neq j}} {v}_{i}^{( k )} , & otherwise ,\end{matrix} \qquad ( 15 )$$

where νᵢ^{(j)*} denotes the optimized value of νᵢ^{(j)}. The value of νᵢ^{(j)*} is used to update νᵢ^{(j)}.

According to EQN. (15), it is observed that the SMSPL technique adopts a new soft weighting strategy, a type of mixture scheme, which faithfully reflects the latent importance of training samples in training. With EQN. (15), the m latent weight vectors can be updated. The goal of this step is to enhance the robustness of training by imposing higher weights or one to high-confidence training samples, whereas assigning smaller weights or zero to low-confidence training samples.

In the step 150, the m pluralities of model parameters are updated according to the multimodal training dataset [symbol] and the m latent weights. The goal of this step is to train the j-th classifier by the identified important samples of the j-th modality. In the step 150, the loss function can be chosen according to the actual problem. For example, log loss and hinge loss functions are typically used for classification problems.

In certain embodiments, a logistic regression model is chosen to train the m classifiers in the step 150. When ν^{(j)} is fixed, EQN. (9) degenerates into a sparse logistic regression optimization problem. Each training sample is associated with a weight reflecting its importance, as given by:

$${min}_{{β}^{( j )}} E ( {β}^{( j )} ; {ν}^{( j )} ; {λ}^{( j )} ) = {\sum }_{i = 1}^{n} {v}_{i}^{( j )} [ {y}_{i} log ( {f}^{( j )} ( {x}_{i}^{( j )} , {β}^{( j )} ) ) + ( 1 - {y}_{i} ) log ( 1 - {f}^{( j )} ( {x}_{i}^{( j )} , {β}^{( j )} ) ) ] + {λ}^{( j )} {‖ {β}^{( j )} ‖}_{1} \qquad ( 16 )$$

As shown in EQN. (16), the sparse logistic regression model is designed based on the L₁ regularization term for feature selection. This optimization problem can be readily solved by the off-the-shelf logistic regression toolbox (e.g., Scikit-Learn in Python). It follows that the m pluralities of model parameters are updated by

$${β}^{( j ) *} = {arg m in}_{{β}^{( j )}} ( {\sum }_{i = 1}^{n} {v}_{i}^{( j )} [ {y}_{i} log ( {f}^{( j )} ( {x}_{i}^{( j )} , {β}^{( j )} ) ) + ( 1 - {y}_{i} ) log ( 1 - {f}^{( j )} ( {x}_{i}^{( j )} , {β}^{( j )} ) ) ] + {λ}^{( j )} {‖ {β}^{( j )} ‖}_{1} ) \qquad ( 17 )$$

where β^{(j)*} is an updated vector of β^{(j)}.

Although FIG. 1 illustrates that the step 140 precedes the step 150 in execution order, the disclosed training method is not limited to this execution order. It is preferable that the step 150 is executed after the step 140 is performed. However, it is also possible that the step 150 is performed before performing the step 140 in an individual running of the iterative process 130.

Once both the m latent weight vectors and the m pluralities of model parameters are refreshed after the steps 140 and 150 are performed, the m age parameters γ⁽¹⁾, γ⁽²⁾, . . . , γ^{(m)} are incremented in the step 160 to allow more training samples with larger loss values to be fed into the training pool in the next iteration. For example, γ^{(j)} can be increased by a step size μ^{(j)} so as to add more training samples in the next iteration.

The updating of the m latent weight vectors, the m pluralities of model parameters and the m age parameters is performed in the iterative process 130. The iterative process 130 is repeated for recursively optimizing the m pluralities of model parameters. The iterative process 130 is repeated until one of predefined terminating conditions occurs (step 170). These terminating conditions may include, e.g., a first condition that a predetermined number of iterations number are performed, a second condition that the m pluralities of model parameters converge, or a third condition that all the n training samples are selected for training the m classifiers. In most practical scenarios, at least the first condition is selected as one terminating condition.

The time complexity for updating the latent weight vectors across multiple modalities is O(n×m) time, while the complexity for finding the optimal solutions of multiple classifiers by using the coordinate descent algorithm is O(n²×p×m). Therefore, the computational complexity of the disclosed training method is O(n²×p×m).

A second aspect of the present disclosure to provide the classifying method for classifying the test sample to yield a classification result. Note that the classification result is a predicted label of the test sample.

As mentioned above, the test sample consists of the m observation data vectors respectively obtained from the m modalities. In case the m observation data vectors are multiomics data, each of the m modalities is a single omics modality.

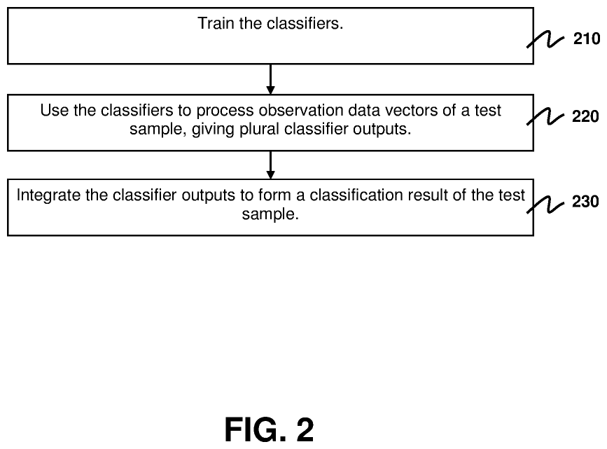

FIG. 2 depicts a flowchart showing exemplary steps of the disclosed classifying method. The m classifiers are used for classifying the m observation data vectors of the test sample, respectively. Before the m classifiers are used to process the m observation data vectors, the m classifiers are trained according to one of the embodiments of the disclosed training method in a step 210. After the m classifiers are trained, the m classifiers process the m observation data vectors, respectively, in a step 220. An individual classifier generates one classifier output so that m classifier outputs are generated. In a step 230, the classification result is determined according to the m classifier outputs. The m classifier outputs are integrated or fused to yield the classification result.

Advantageously and preferably, the predictive label or the classification result for the test sample is obtained by solving an optimization problem given by

$$s = {arg min}_{s ∈ G} {\sum }_{j = 1}^{m} L ( s , {f}^{( j )} ( {r}^{( j )} , {β}^{( j )} ) ) , \qquad ( 18 )$$

where: s is the classification result; G is a set of allowable classification results, e.g., G={0,1} for binary classification; r^{(j)} is a j-th observation data vector of the test sample; β^{(j)} denotes a plurality of model parameters used in the j-th classifier; and f^{(j)}(r^{(j)}, β^{(j)}) is a j-th classifier output generated by the j-th classifier under r^{(j)} and β^{(j)}; and L(s, f^{(j)}(r^{(j)}, β^{(j)})), computed according to the loss function L(·,·), is a loss of selecting s under f^{(j)}(r^{(j)}, β^{(j)}). The last-mentioned loss is computed according to the loss function L(·,·) used in training the m classifiers in the step 210. Note that the classification result obtained by EQN. (18) minimizes a sum of m losses each of which is a loss of selecting a candidate classification result under a classifier output.

The embodiments of the training and classifying methods disclosed herein may be implemented using a general purpose computer, a specialized computing device, a computing server, a mobile computing device, a computer processor, or electronic circuitry including but not limited to a digital signal processor (DSP), an application specific integrated circuit (ASIC), a field programmable gate array (FPGA), and other programmable logic device configured or programmed according to the teachings of the present disclosure. Computer instructions or software codes running in the general purpose or specialized computing device, computer processor, or programmable logic device can readily be prepared by practitioners skilled in the software or electronic art based on the teachings of the present disclosure. Generally, the training method and the classifying methods as disclosed herein are computer-implemented.

As a remark, the SMSPL technique as disclosed herein mainly differs from current supervised multiomics data integration methods in the following four aspects.

First aspect: Instead of ignoring linkages between multiple modalities by the existing methods, such as concatenation-based and ensemble-based integration methods, the SMSPL technique leverages the interaction among different modalities to recommend high-confidence samples for training the classifiers. In the SMSPL technique, according to EQN. (15), the confidence threshold of a training sample is related to parameters γ⁽ⁱ⁾, δ and the latent weights of the corresponding observation data vectors in other modalities Σ_{1≤k≤m,k≠j} νᵢ^{(k)}. It implies that an individual classifier has a greater tendency to choose training samples that are recommended from other modalities than training samples that are not. It takes advantage of common knowledge in sharing sample confidence among multiple modalities.

Second aspect: When updating the training pool in one modality, the SMSPL technique not only selects high-confidence training samples justified by the other modalities, but also might feed into the pool a few high-confidence samples that are obtained with very small loss values calculated on the current modality. This strategy is expected to make the disclosed methods utilize more reliable high-confidence knowledge from the prediction knowledge of the current classier.

Third aspect: Instead of using the average or majority voting scheme to predict class labels of test samples (e.g., ensemble-based and DIABLO), the disclosed methods predict sample labels by solving EQN. (18). This might make the disclosed methods more accruable to discriminate equivocal samples.

Fourth aspect: The disclosed methods are a variant of the SPL regime. (The SPL regime is robust in the outliers/heavy noise situation.) In the presence of heavy noise or extreme outliers, learning in a meaningful order and sample weighting scheme can enhance the robustness of training and improve the generalization capacity of a classifier. Experimental results, not shown here, demonstrate that the SMSPL technique has a desired generalization capacity compared with other state-of-the-art supervised multiomics data integration techniques.

The present invention may be embodied in other specific forms without departing from the spirit or essential characteristics thereof. The present embodiment is therefore to be considered in all respects as illustrative and not restrictive. The scope of the invention is indicated by the appended claims rather than by the foregoing description, and all changes that come within the meaning and range of equivalency of the claims are therefore intended to be embraced therein.

### LIST OF REFERENCES

[1] Y. Freund and R. E. Schapire, “A decision-theoretic generalization of on-line learning and an application to boosting,” Journal of computer and system sciences, vol. 55, no. 1, pp. 119-139, 1997.
[2] T.-Y. Lin, P. Goyal, R. Girshick, K. He, and P. Dollár, “Focal loss for dense object detection,” 2018.
[3] M. P. Kumar, B. Packer, and D. Koller, “Self-paced learning for latent variable models,” in Advances in Neural Information Processing Systems, 2010, pp. 1189-1197.
[4] L. Jiang, D. Meng, T. Mitamura, and A. G. Hauptmann, “Easy samples first: Self-paced reranking for zero-example multimedia search,” in Proceedings of the 22nd ACM international conference on Multimedia, A C M, 2014, pp. 547-556.
[5] L. Jiang, D. Meng, S.-I. Yu, Z. Lan, S. Shan, and A. Hauptmann, “Self-paced learning with diversity,” in Advances in Neural Information Processing Systems, 2014, pp. 2078-2086.
[6] Y. Wang, A. Kucukelbir, and D. M. Blei, “Robust probabilistic modeling with bayesian data reweighting,” in Proceedings of the 34th International Conference on Machine Learning-Volume 70, JMLR. org, 2017, pp. 3646-3655.
[7] T. Malisiewicz, A. Gupta, A. A. Efros et al., “Ensemble of exemplarsvms for object detection and beyond.” in Iccv, vol. 1, no. 2. Citeseer, 2011, p. 6.
[8] F. De La Torre and M. J. Black, “A framework for robust subspace learning,” International Journal of Computer Vision, vol. 54, no. 1-3, pp. 117-142, 2003.
[9] Z. Zhang and M. Sabuncu, “Generalized cross entropy loss for training deep neural networks with noisy labels,” in Advances in Neural Information Processing Systems, 2018, pp. 8778-8788.

What is claimed is:

1. A method for training m classifiers, the m classifiers being collectively used for classifying a test sample consisting of m observation data vectors respectively obtained from m modalities where m≥2, a j-th classifier being used for classifying a j-th observation data vector generated from a j-th modality where 1≤j≤m, the j-th classifier including a plurality of model parameters updatable during training such that the m classifiers include m pluralities of model parameters, the method comprising the steps of:
(a) obtaining a multimodal training dataset comprising n training samples for training the m classifiers, wherein an individual training sample comprises m observation data vectors and a predetermined class label;
(b) initializing m latent weight vectors, m age parameters, an inter-modality influencing factor and the m pluralities of model parameters, wherein a j-th latent weight vector comprises n latent weights each indicating a degree of importance of a j-th observation data vector of a respective training sample during training the j-th classifier, wherein a j-th age parameter is used for adjusting a learning pace in self-paced learning of the j-th classifier during training, and wherein the inter-modality influencing factor is used for adjusting a degree of influence of a k-th latent weight vector to training the j-th classifier where k≠j, the inter-modality influencing factor being same for j=1, . . . , m; and
(c) repeating an iterative process for iteratively updating the m pluralities of model parameters until one of predefined terminating conditions occurs, wherein the iterative process comprises the steps of:
(d) updating the m latent weight vectors according to the m age parameters, the inter-modality influencing factor and the m pluralities of model parameters;
(e) updating the m pluralities of model parameters according to the dataset and the m latent weights; and
(f) after the steps (d) and (e) are performed, incrementing the m age parameters.

2. The training method of claim 1, wherein in the step (d), the m latent weights are updated by
$${v}_{i}^{( j ) *} = \{ \begin{matrix}1 , & i f {L}_{i}^{( j )} < {γ}^{( j )} + \frac{δ}{m - 1} {\sum }_{{1 \leq k \leq m}_{k \neq j}} {v}_{i}^{( k )} - δ , \\ 0 , & if {L}_{i}^{( j )} > {γ}^{( j )} + \frac{δ}{m - 1} {\sum }_{{1 \leq k \leq m}_{k \neq j}} {v}_{i}^{( k )} , \\ \frac{\begin{matrix}{γ}^{( j )} - \\ {L}_{i}^{( j )}\end{matrix}}{δ} + \frac{1}{m - 1} {\sum }_{{1 \leq k \leq m}_{k \neq j}} {v}_{i}^{( k )} , & otherwise\end{matrix} ,$$
where:
Lᵢ^{(j)} is given by Lᵢ^{(j)}=L(yᵢ, f^{(j)}(xᵢ^{(j)}, β^{(j)})) in which L(·,·) is a predetermined loss function for computing a loss of selecting yᵢ under f^{(j)}(xᵢ^{(j)}, β^{(j)}), xᵢ^{(j)} is the j-th observation data vector of an i-th training sample in the dataset, yᵢ is the predetermined class label of the i-th training sample, β^{(j)} is the plurality of model parameters of the j-th classifier, and f^{(j)}(xᵢ^{(j)}, β^{(j)}) is a classifier output generated by the j-th classifier under xᵢ^{(j)} and β^{(j)};
the m latent weight vectors are denoted by ν⁽¹⁾, . . . , ν^{(m)} with ν^{(j)}=(ν₁^{(j)}, . . . , νₙ^{(j)}) in which νᵢ^{(j)} is a respective latent weight indicating the degree of importance of xᵢ^{(j)} during training the j-th classifier;
νᵢ^{(j)*} is an updated value of νᵢ^{(j)};
γ^{(j)} is a j-th age parameter; and
δ is the inter-modality influencing factor.

3. The training method of claim 1, wherein in the iterative process, performing the step (d) precedes performing the step (e).

4. The training method of claim 1, wherein in the iterative process, performing the step (e) precedes performing the step (d).

5. The training method of claim 1, wherein in the step (b), the m pluralities of model parameters are initialized with model-parameter values obtained in a previous training phase.

6. The training method of claim 1, wherein in the step (b), the m pluralities of model parameters are initialized with predetermined model-parameter values.

7. The training method of claim 2, wherein in the step (e), the m pluralities of model parameters are updated by
$${β}^{( j ) *} = {arg m in}_{{β}^{( j )}} ( {\sum }_{i = 1}^{n} {v}_{i}^{( j )} [ {y}_{i} log ( {f}^{( j )} ( {x}_{i}^{( j )} , {β}^{( j )} ) ) + ( 1 - {y}_{i} ) log ( 1 - {f}^{( j )} ( {x}_{i}^{( j )} , {β}^{( j )} ) ) ] + {λ}^{( j )} {‖ {β}^{( j )} ‖}_{1} )$$
where:
β^{(j)*} is an updated vector of β^{(j)};
∥β^{(j)}∥₁ is a regularization term for the j-th classifier;
λ^{(j)} is a tuning parameter of the regularization term; and
∥·∥₁ is a Lasso penalty function.

8. The training method of claim 1, wherein the predefined terminating conditions include a first condition that a predetermined number of iterations are performed, a second condition that the m pluralities of model parameters converge, or a third condition that all the n training samples are selected for training the m classifiers.

9. A method for classifying a test sample to yield a classification result, the test sample consisting of m observation data vectors obtained from m modalities where m≥2, the method comprising:
using m classifiers to respectively process the m observation data vectors, whereby m classifier outputs are generated;
determining the classification result according to the m classifier outputs; and
before using the m classifiers to process the m observation data vectors, training the m classifiers according to the training method of claim 1.

10. The classifying method of claim 9, wherein the classification result is determined from the m classifier outputs by
$$s = {arg min}_{s ∈ G} {\sum }_{j = 1}^{m} L ( s , {f}^{( j )} ( {r}^{( j )} , {β}^{( j )} ) ) ,$$
where:
s is the classification result;
G is a set of allowable classification results;
r^{(j)} is a j-th observation data vector of the test sample;
β^{(j)} denotes a plurality of model parameters used in the j-th classifier; and
f^{(j)}(r^{(j)}, β^{(j)}) is a j-th classifier output generated by the j-th classifier under r^{(j)} and β^{(j)}; and
L(s, f^{(j)}(r^{(j)}, β^{(j)})) is a loss of selecting s under f^{(j)}(r^{(j)}, β^{(j)}), wherein L(·,·) is a predetermined loss function.

11. The classifying method of claim 10, wherein each of the m modalities is a single omics modality.

12. A method for classifying a test sample to yield a classification result, the test sample consisting of m observation data vectors obtained from m modalities where m≥2, the method comprising:
using m classifiers to respectively process the m observation data vectors, whereby m classifier outputs are generated;
before using the m classifiers to process the m observation data vectors, training the m classifiers according to the training method of claim 2; and
determining the classification result according to the m classifier outputs by
$$s = {arg min}_{s ∈ G} {\sum }_{j = 1}^{m} L ( s , {f}^{( j )} ( {r}^{( j )} , {β}^{( j )} ) ) ,$$
where:
s is the classification result;
G is a set of allowable classification results;
r^{(j)} is a j-th observation data vector of the test sample;
β^{(j)} denotes a plurality of model parameters used in the j-th classifier; and
f^{(j)}(r^{(j)}, β^{(j)}) is a j-th classifier output generated by the j-th classifier under r^{(j)} and β^{(j)}; and
L(s, f^{(j)}(r^{(j)}, β^{(j)})) is a loss of selecting s under f^{(j)}(r^{(j)}, β^{(j)}), wherein L(·,·) is the predetermined loss function.

13. A method for classifying a test sample to yield a classification result, the test sample consisting of m observation data vectors obtained from m modalities where m≥2, the method comprising:
using m classifiers to respectively process the m observation data vectors, whereby m classifier outputs are generated;
before using the m classifiers to process the m observation data vectors, training the m classifiers according to the training method of claim 3; and
determining the classification result according to the m classifier outputs by
$$s = {arg min}_{s ∈ G} {\sum }_{j = 1}^{m} L ( s , {f}^{( j )} ( {r}^{( j )} , {β}^{( j )} ) ) ,$$
where:
s is the classification result;
G is a set of allowable classification results;
r^{(j)} is a j-th observation data vector of the test sample;
β^{(j)} denotes a plurality of model parameters used in the j-th classifier; and
f^{(j)}(r^{(j)}, β^{(j)}) is a j-th classifier output generated by the j-th classifier under r^{(j)} and β^{(j)}; and
L(s, f^{(j)}(r^{(j)}, β^{(j)})) is a loss of selecting s under f^{(j)}(r^{(j)}, β^{(j)}), wherein L(·,·) is a predetermined loss function.

14. A method for classifying a test sample to yield a classification result, the test sample consisting of m observation data vectors obtained from m modalities where m≥2, the method comprising:
using m classifiers to respectively process the m observation data vectors, whereby m classifier outputs are generated;
before using the m classifiers to process the m observation data vectors, training the m classifiers according to the training method of claim 4; and
determining the classification result according to the m classifier outputs by
$$s = {arg min}_{s ∈ G} {\sum }_{j = 1}^{m} L ( s , {f}^{( j )} ( {r}^{( j )} , {β}^{( j )} ) ) ,$$
where:
s is the classification result;
G is a set of allowable classification results;
r^{(j)} is a j-th observation data vector of the test sample;
β^{(j)} denotes a plurality of model parameters used in the j-th classifier; and
f^{(j)}(r^{(j)}, β^{(j)}) is a j-th classifier output generated by the j-th classifier under r^{(j)} and β^{(j)}; and
L(s, f^{(j)}(r^{(j)}, β^{(j)})) is a loss of selecting s under f^{(j)}(r^{(j)}, β^{(j)}), wherein L(·,·) is a predetermined loss function.

15. A method for classifying a test sample to yield a classification result, the test sample consisting of m observation data vectors obtained from m modalities where m≥2, the method comprising:
using m classifiers to respectively process the m observation data vectors, whereby m classifier outputs are generated;
before using the m classifiers to process the m observation data vectors, training the m classifiers according to the training method of claim 5; and
determining the classification result according to the m classifier outputs by
$$s = {arg min}_{s ∈ G} {\sum }_{j = 1}^{m} L ( s , {f}^{( j )} ( {r}^{( j )} , {β}^{( j )} ) ) ,$$
where:
s is the classification result;
G is a set of allowable classification results;
r^{(j)} is a j-th observation data vector of the test sample;
β^{(j)} denotes a plurality of model parameters used in the j-th classifier; and
f^{(j)}(r^{(j)}, β^{(j)}) is a j-th classifier output generated by the j-th classifier under r^{(j)} and β^{(j)}; and
L(s, f^{(j)}(r^{(j)}, β^{(j)})) is a loss of selecting s under f^{(j)}(r^{(j)}, β^{(j)}), wherein L(·,·) is a predetermined loss function.

16. A method for classifying a test sample to yield a classification result, the test sample consisting of m observation data vectors obtained from m modalities where m≥2, the method comprising:
using m classifiers to respectively process the m observation data vectors, whereby m classifier outputs are generated;
before using the m classifiers to process the m observation data vectors, training the m classifiers according to the training method of claim 6; and
determining the classification result according to the m classifier outputs by
$$s = {arg min}_{s ∈ G} {\sum }_{j = 1}^{m} L ( s , {f}^{( j )} ( {r}^{( j )} , {β}^{( j )} ) ) ,$$
where:
s is the classification result;
G is a set of allowable classification results;
r^{(j)} is a j-th observation data vector of the test sample;
β^{(j)} denotes a plurality of model parameters used in the j-th classifier; and
f^{(j)}(r^{(j)}, β^{(j)}) is a j-th classifier output generated by the j-th classifier under r^{(j)} and β^{(j)}; and
L(s, f^{(j)}(r^{(j)}, β^{(j)})) is a loss of selecting s under f^{(j)}(r^{(j)}, β^{(j)}), wherein L(·,·) is a predetermined loss function.

17. A method for classifying a test sample to yield a classification result, the test sample consisting of m observation data vectors obtained from m modalities where m≥2, the method comprising:
using m classifiers to respectively process the m observation data vectors, whereby m classifier outputs are generated;
before using the m classifiers to process the m observation data vectors, training the m classifiers according to the training method of claim 7; and
determining the classification result according to the m classifier outputs by
$$s = {arg min}_{s ∈ G} {\sum }_{j = 1}^{m} L ( s , {f}^{( j )} ( {r}^{( j )} , {β}^{( j )} ) ) ,$$
where:
s is the classification result;
G is a set of allowable classification results;
r^{(j)} is a j-th observation data vector of the test sample;
β^{(j)} denotes a plurality of model parameters used in the j-th classifier; and
f^{(j)}(r^{(j)}, β^{(j)}) is a j-th classifier output generated by the j-th classifier under r^{(j)} and β^{(j)}; and
L(s, f^{(j)}(r^{(j)}, β^{(j)})) is a loss of selecting s under f^{(j)}(r^{(j)}, β^{(j)}), wherein L(·,·) is the predetermined loss function.

18. A method for classifying a test sample to yield a classification result, the test sample consisting of m observation data vectors obtained from m modalities where m≥2, the method comprising:
using m classifiers to respectively process the m observation data vectors, whereby m classifier outputs are generated;
before using the m classifiers to process the m observation data vectors, training the m classifiers according to the training method of claim 8; and
determining the classification result according to the m classifier outputs by
$$s = {arg min}_{s ∈ G} {\sum }_{j = 1}^{m} L ( s , {f}^{( j )} ( {r}^{( j )} , {β}^{( j )} ) ) ,$$
where:
s is the classification result;
G is a set of allowable classification results;
r^{(j)} is a j-th observation data vector of the test sample;
β^{(j)} denotes a plurality of model parameters used in the j-th classifier; and
f^{(j)}(r^{(j)}, β^{(j)}) is a j-th classifier output generated by the j-th classifier under r^{(j)} and β^{(j)}; and
L(s, f^{(j)}(r^{(j)}, β^{(j)})) is a loss of selecting s under f^{(j)}(r^{(j)}, β^{(j)}), wherein L(·,·) is a predetermined loss function.
